(19) United States
(12) Patent Application Publication
(10) Pub. No.: US 2026/0017679 A1
(43) Pub. Date: Jan. 15, 2026

(54) METHOD AND SYSTEM FOR DETECTING CAUSAL REASONS FOR DETERMINING APPROPRIATE TREATMENTS AND APPLICATIONS THEREOF

(71) Applicant: Verizon Patent and Licensing Inc., Basking Ridge, NJ (US)

(72) Inventors: Varun Unnikrishnannair, Bangalore (IN); Sri Harsha Manne, Hyderabad (IN); Koyal Roy, Hyderabad (IN); Ebenezer Bardhan, Chennai (IN); Satish B. Seela, Irving, TX (US); Yash Chandra, Ghaziabad (IN)

(73) Assignee: Verizon Patent and Licensing Inc., Basking Ridge, NJ (US)

(21) Appl. No.: 18/772,969

(22) Filed: Jul. 15, 2024

(51) Int. Cl. G06Q 30/0202

(52) U.S. Cl. CPC G06Q 30/0202

(57) ABSTRACT

The present teaching relates to detecting causal reasons for certain action and determining treatments to prevent the action. Information on services to users is collected and used to generate targeted segments of users, each of which corresponds to a level of risk associated with a user action with users estimated at the level of risk. The information is also used to generate causal segments, each of which corresponds to a causal reason that causes the user action. Based on the targeted segments and causal segments, causal reason(s) associated with each user to carry out the user action is estimated. A market action directed to each estimated causal reasons may be automatically recommended and executed to prevent a user to carry out the user action.

### BACKGROUND

Today, a high percent of the population receives a variety of online services/applications/information in their daily lives via ubiquitous network connections. Service companies emerge daily to offer new or improved online services. Customers of one service company may receive promotions or improved service terms from different service companies and some of the customers may switch service providers to seek better terms or experiences. This is called churn, which may occur without any unsatisfactory experience with the current service provider. To compete in the marketplace, online service providers try to prevent churn via different means such as offering enhanced services or periodic promotions.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary waterfall framework for preventing churn via market actions determined based on causal reasons automatically estimated with respect to customers, in accordance with an exemplary embodiment of the present teaching;

FIG. 1B is a flowchart of an exemplary waterfall process of preventing churn via market actions determined based on causal reasons automatically estimated with respect to different customers, in accordance with an exemplary embodiment of the present teaching;

FIG. 1C shows exemplary groupings of customers into hyper targeted churn (HTC) segments of different churn risk levels as well as causal segments, in accordance with an embodiment of the present teaching;

FIG. 2A illustrates exemplary types of information used for determining churn risks and causal reasons thereof with respect to different customers, in accordance with an embodiment of the present teaching;

FIG. 2B illustrates an exemplary information transformation flow for churn prevention, from information collection, feature extraction, risk assessment, causal reasons prediction, to market actions to prevent churn, in accordance with an embodiment of the present teaching;

FIG. 2C provides an example of determining a market action for a customer based on a churn risk level and causal reasons estimated for the customer, in accordance with an exemplary embodiment of the present teaching;

FIG. 3A depicts an exemplary high level system diagram of a HTC segment generator, in accordance with an embodiment of the present teaching;

FIG. 3B is a flowchart of an exemplary process for generating HTC segments via an HTC model based on features extracted from information collected, in accordance with an embodiment of the present teaching;

FIG. 3C is a flowchart of an exemplary process for obtaining an HTC model via machine learning based on past churning data, in accordance with an embodiment of the present teaching;

FIG. 3D provides an example different use case of the present teaching for identifying causal reasons for network malfunction and automatic determination and execution of targeted treatment to minimize network malfunction, according to an embodiment of the present teaching;

FIG. 4A depicts an exemplary high level system diagram of a causal segment generator, in accordance with an embodiment of the present teaching;

FIG. 4B is a flowchart of an exemplary process for a causal segment generator, in accordance with an embodiment of the present teaching;

FIG. 4C shows an example result of obtained causal segments with customers classified therein, in accordance with an embodiment of the present teaching;

FIG. 5A depicts an exemplary high level system diagram of a market action recommender, in accordance with an embodiment of the present teaching;

FIG. 5B illustrates an exemplary information transformation to determine a market action, in accordance with an embodiment of the present teaching;

FIG. 5C illustrates recommended market actions to prevent churn with respect to each of a number of customers based on individually assessed overall risks and causal reasons/drivers associated therewith, in accordance with an embodiment of the present teaching;

FIG. 5D is a flowchart of an exemplary process of a market action recommender, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

Service providers are expected to ensure an expected quality of services (QoS) for their customers. To achieve that, it is important to predict, based on observations, when problems may occur and accordingly the measures to be deployed to address the problems that may affect QoS. Predicted problems may involve operational issues or customer service issues and the like. For example, in network services, problems may occur during the operation of network components. In this case, prediction of such problems may facilitate earlier treatments to prevent these problems from occurring. On the other hand, issues may also arise from customers during their use of a service. For instance, a service provider needs to not only expand its customer base but also, more importantly, retain existing customers by, e.g., detecting their dissatisfaction and addressing it accordingly.

Probabilistic models have been developed in the past to estimate the likelihood of occurrences of some undesirable events (e.g., failed network connection, breached network security, or some customers' tendency to switch to a different service provider, etc.) based on data observed during provisioning and use of these services. However, these traditional approaches using probabilistic models do not offer more than a probability of occurrence of a problem such as possible churn, network device decline or failure, or the like. Therefore, these approaches lack the ability to provide useful guidance in terms of the underlying reasons that drive the probability or causality between the observations and the probabilities. As such, a prediction using a traditional probabilistic model cannot be used to prevent an undesirable event from happening. For instance, if a prediction indicates that there is a high probability that the connection in a regional network may fail, it does not indicate what may be the cause of the estimated failure. Similarly, if a customer is predicted to churn by a probabilistic model based on various information associated with the customer, it provides no assistance in terms of how to prevent this churn event. That is, the traditional probabilistic models cannot bridge the gap between estimating a possibility of an event and prevention thereof, because a likelihood measure does not capture adequate and useful information that may explain the causal factors behind the estimated probability. In the case of predicting customer churn, the traditional probabilistic models cannot assist, e.g., a marketing team, to accordingly determine a market action in its strategic planning that aims to address the individual concerns of the customer, to improve the level of customer satisfaction, and to effectively prevent the concerned customer from churning. Similarly, predicting network element failure does not assist a technical team in determining the reason for failure and possibly preventing such failure.

The present teaching discloses a framework with an operational flow for automatically and dynamically estimating, via artificial intelligence (AI) modeling via machine learning, both a level of risk for some event to happen and the causal reason(s) behind the estimated level of risk so that the causality information can be used to automatically identify treatments directed to the causal reason(s) to minimize the risk. The present teaching may be applied to different applications in this flow with four (4) phases to (1) predict the likelihood for some event to happen, (2) identify causal reason(s) associated with each predicted likelihood, (3) determine automatically targeted treatment with respect to each causal reason, and (4) deploy the target treatment(s) to remove the causal reason(s) to minimize the predicted risks in a causality-aware manner. Examples of this 4-phase operation may be applied to applications such as network operation (by identifying likely network failure and its causal reasons and automatically deploy treatments to prevent), customer retention (by predicting the likelihood of customers' churn and causes associated with each so that market treatment may be adopted to prevent churn), software diagnosis (by recognizing likely dysfunctional event and the causes), health care (by estimating causes from symptoms to develop on-the-target treatment), etc.

Although the present teaching can be applied in a variety of technology areas, for the ease of presentation, the present teaching is illustrated herein using an exemplary application of customer retention. That is, although the 4-phase operation in a waterfall scheme is described with respect to customer retention (i.e., estimating the risks of a churn event of each customer, identifying causal reason(s) of each risky customer, determining treatment for each cause of each customer, and execute the treatment to minimize the risk), the process of these four phases can be similarly carried out in different use cases. In the use case of customer retention or prevention of customer churn, the risk level associated with each customer on churning may first be estimated based on various types of information monitored. For each customer with a risk of churn, causal reason(s) that drives the risk may be identified automatically via machine learning. The identified causal reasons for each customer may be used to determine appropriate targeted market actions. Such determined market actions may be carried out to resolve the underlying causal reasons to minimize the risk of churning. Thus, by automatically identifying such causality, a marketing team may implement appropriate interventions and strategies to mitigate churn for high-risk customers. As such, the causal model of the present teaching provides deeper insights to reveal the underlying factors and drivers that lead to a predicted risk, i.e., customers to leave a service or a product, providing guidance to a business to prioritize resources and efforts more efficiently.

To understand the causality in this exemplary use case, customers may be classified into different segments, including hyper targeted churn (HTC) segments and causal segments. When in other use cases, this may be generally regarded as different segments corresponding to different risk levels. The HTC segments are generated according to the churning risk levels estimated via an HTC model based on features extracted from information related to customers' services/activities. Customers may also be grouped via causal drivers/reasons and causal segments may be generated in accordance with a causal model based on features associated with the customers, services, and activities. The HTC and the causal models may be trained via machine learning using, e.g., historic data associated with the past churning. The HTC model is trained to recognize the levels of risk of churn via customer activities and events. The causal model is for capturing, via machine learning, the causality or recognizing signals from customers' behavior, expressions, activities, and profiles in terms of what drive customers to churn.

The HTC segments and causal segments form the basis to identify customers with high risk of churn and individual causal drivers/reasons associated with the detected risk of churn. Based on such information, market actions may be determined and carried out to remedy the reasons and reduce or even eliminate the high risk of churn, according to the present teaching. The market actions that are suitable for addressing corresponding concerns or dissatisfactions may be modeled. In some embodiments, the modeling may be based on past operational data and obtained via machine learning. In some embodiments, the mapping may also be developed as a look up table with individual mappings obtained via past treatments in similar situations. Such a mapping model may then be used to map causal drivers/reasons identified to market actions.

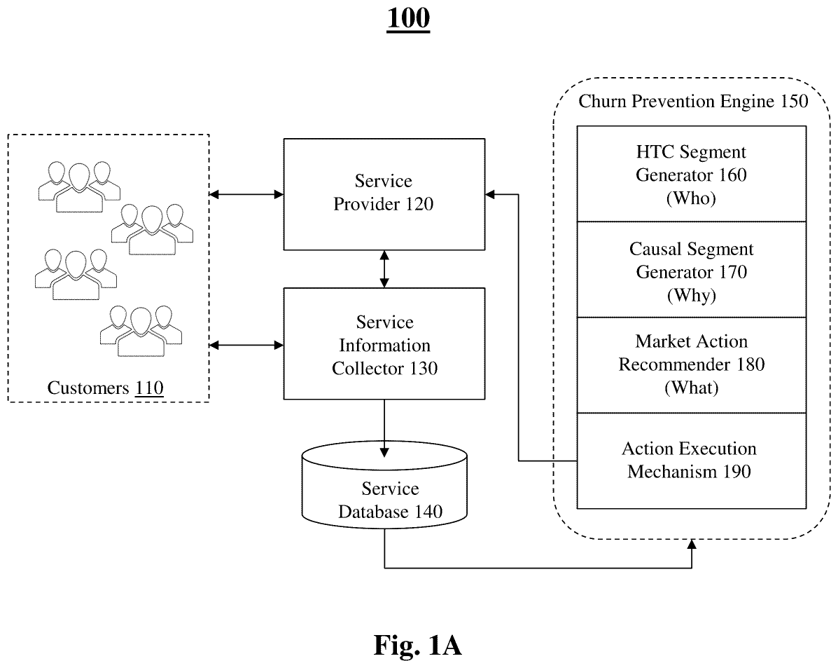

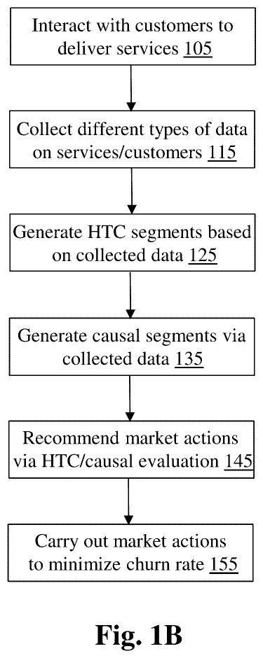

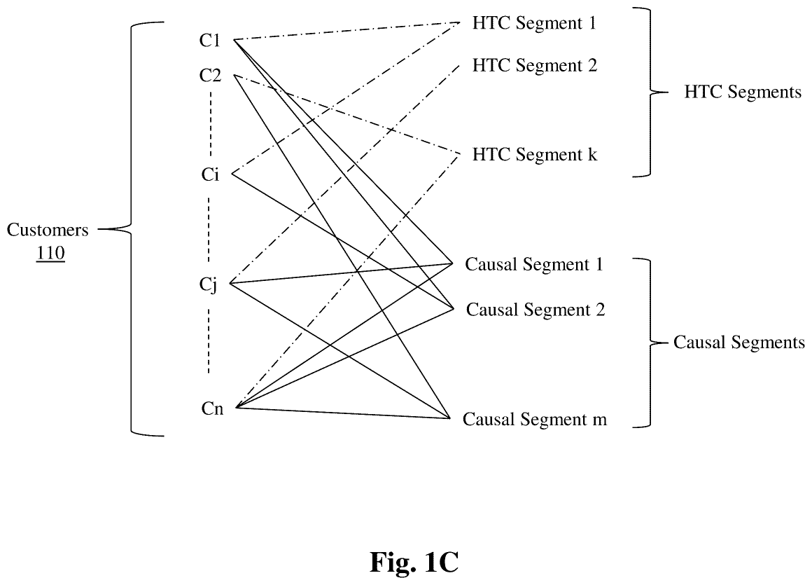

FIG. 1A depicts an exemplary waterfall framework 100 for preventing churn (or to any undesirable event such as a software or network failure) via actions (e.g., market actions, or generally, measures and actions used to prevent an undesirable event from happening) determined based on causal reasons automatically estimated with respect to customers (or generally the causal reasons related to factors that may attribute to the undesirable event), in accordance with an exemplary embodiment of the present teaching. In this illustrated embodiment, the framework 100 comprises a service provider 120, a service information collector 130, and a churn prevention engine 150. The service provider 120 operates to provide services to a plurality of customers 110. The service information collector 130 is provided to gather a variety type of information and store such collected information in a service database 140. The churn prevention engine 150 is provided to prevent churn of those customers that are identified as having a high risk of churn due to some causal reasons estimated based on the information stored in the service database 140.

In this illustrated embodiment, the churn prevention engine 150 is realized in a waterfall scheme implemented by an HTC segment generator 160, a causal segment generator 170, a market action recommender 180, and an action execution mechanism 190. With the illustrated waterfall scheme, the HTC segment generator 160 is provided to identify who of the customers 110 are at a high risk of churn. The causal segment generator 170 is provided to identify what are the causal reasons associated with each customer with a risk of churning that explain why the customer may churn. The market action recommender 180 is provided to determine what needs to be done to prevent the likely churning event, i.e., the specific market actions to take to address the causal reasons that have been identified. With the recommended market actions, the action execution mechanism 190 operates to work with the service provider 120 to carry out the recommended market actions in connection with each high-risk customer.

For example, if the collected information reveals that a customer has contacted with the service provider 120 on the level of charge in the last few months, the last month's payment has not yet been received, and the customer has been checking online information on how to switch to a different service provider, then such activities may signal that the customer intends to switch and the reason that may have caused the desire to switch is due to price issue. Given that, a market action recommended to address the customer's concern over cost may include an offer of some service package that will bring down the cost to the customer or a new promotion for the same purpose to reduce the charge to the customer. As discussed herein, the market action is now recommended based on the estimated causal reason that drives the customer to churn so that the market action may ease the customer's concern so that to prevent the customer from leaving.

FIG. 1B is a flowchart of an exemplary waterfall process of preventing churn via market actions determined based on causal reasons automatically estimated with respect to different customers, in accordance with an exemplary embodiment of the present teaching. The service provider 120 interacts with the customers 110 at 105 to deliver services. During the service process, the customers 110 and the service provider 120 may communicate about various matters, e.g., subscribing services with different terms, issues associated with subscriptions, changes to the service terms, reporting service quality issues, discussing payment issues, scheduling repairs, etc. During the services, the service provider 120 may also make observations over the customers' activities, such as different websites visited, searches performed on the Internet, different types of information browsed, or online transactions carried out, etc. The interaction communications as well as observed customer activities may be collected, at 115, by the service information collector 130 and archived in the service database 140. As will be discussed below, such collected information may be utilized for preventing churn according to the present teaching.

Based on the collected information, the HTC segment generator 160 may evaluate customers as to the level of rick to churn and generate, at 125, HTC segments by assessing the churn risk of each of the customers using different types of information in the service database 140. Each of the HTC segments may include one or more customers who are evaluated to have the same level of churn risk determined based on data relevant to the customers. In this illustrated waterfall scheme, the causal segment generator 170 may also leverage the information in the service database 140 to generate, at 135, causal segments. Each causal segment may correspond to a specific causal reason which may drive a customer to churn. A causal segment may include one or more customers who are recognized to be linked to the causal reason associated with the causal segment. A customer may have multiple reasons that may attribute to churn (e.g., dissatisfied with the service charges in the last few months and encountered issues in defective device sent to resident). In this case, the same customer be included in different causal segments. In some embodiments, the level of risk of churn may also be impacted when a customer has more than one causal reason related to churn.

FIG. 1C shows exemplary groupings of customers into HTC segments corresponding to different churn risk levels as well as causal segments associated with different causal reasons, in accordance with an embodiment of the present teaching. As shown, there are exemplary n customers 110, including C₁, C₂, . . . , Cₙ. In this illustration, the dotted lines show groupings of customers into HTC segments and solid lines show groupings of customers into causal segments. For example, customer C₁ is grouped into HTC segment 1, causal segment 1, and causal segment 2. That is, collected data on customer C₁ may indicate that this customer may have two underlying reasons that may drive the customer at a risk level of HTC segment 1. Similarly, customer Cⱼ is classified into causal segment 1 and causal segment m, corresponding also to two separate reasons that may drive customer Cⱼ to churn at a risk level associated with HTC segment 2.

Via HTC segments and causal segments, each customer may be recognized to be at a certain level of risk to churn with some specific causal reason(s). Such classification results (HTC and causal segments) may then be used by the market action recommender 180 to further determine, e.g., for each customer a certain level of risk of churn, a recommended market action, at 145, specifically directed to each identified causal reason to prevent the churn. The market action(s) individually recommended for each customer may then be carried out at 155 to address the causal reason(s) associated therewith to prevent the churn or minimize the chance of churning. As each market action is determined with respect to each causal reason estimated with respect to a customer based on collected information, the waterfall scheme according to the present teaching is capable of churn prevention in a purposeful way by understanding the specific reasons that may attribute to the churn and targeting to remove those specific reasons that may make a customer to churn.

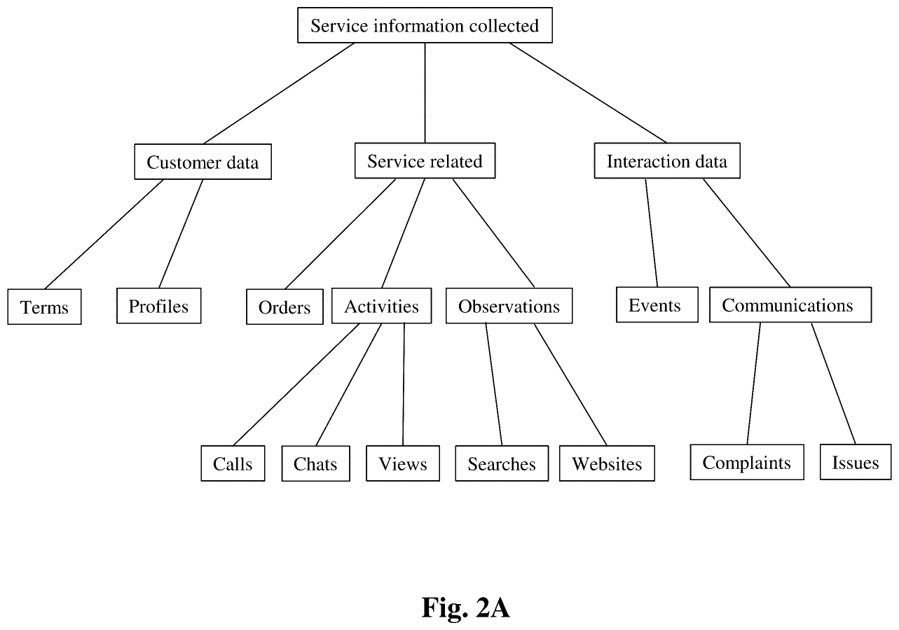

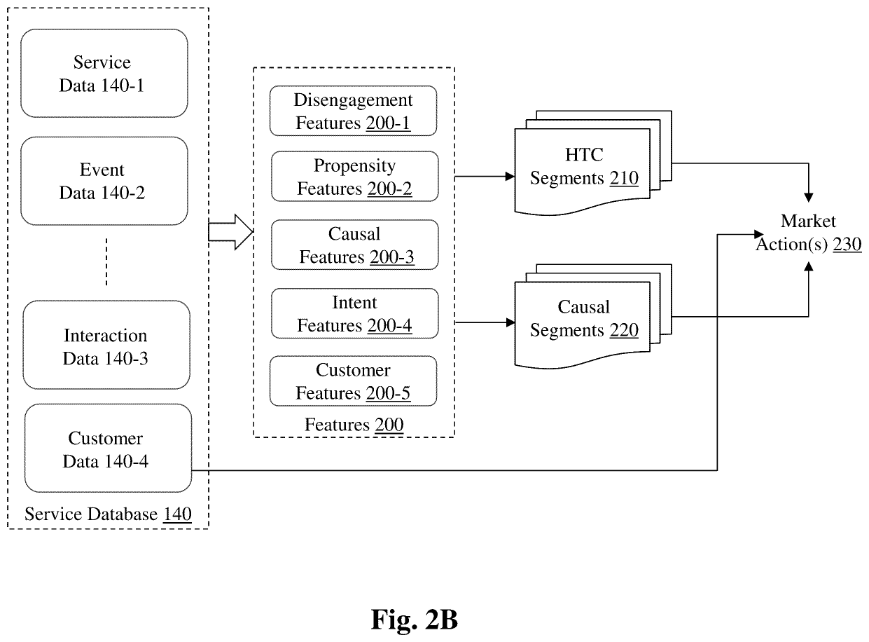

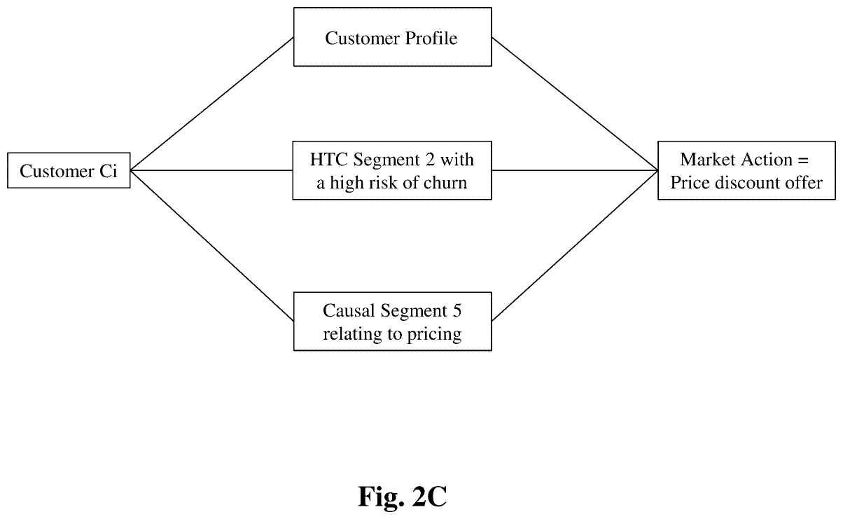

As discussed herein, to estimate a level of churn risk and identify causal reasons associated therewith, information related to the services, communications, activities, and observations may be collected and relied on. FIG. 2A illustrates exemplary types of information that may be gathered and used for determining churn risks and causal reasons thereof with respect to different customers, in accordance with an embodiment of the present teaching. As shown, information collected during the services may include customer related data, service-related data, and data related to interactions between the customers and the service provider. Customer related data may include customer profiles on information such as customers' demographics, preferences, etc. or service terms specific to the subscription of each customer. The service-related data may include information on various transactions (e.g., purchases of devices and prices/dates thereof), customer activities (e.g., calls made, chats conducted, views created, etc.), or observations made on the customers during the services (e.g., searches performed, or websites visited, etc.). The interaction data may include information on events (e.g., promotions presented, promotions declined/accepted, etc.) or communications between the service provider and the customers (e.g., complaints from customers, or issues reported/fixed, etc.).

These different types of information may reveal, particularly when in combination, certain signals related to a customer's propensity or intent to churn as well as the underlying causal reasons that may drive the customer's intent to churn. For example, if a customer contacted the service provider 120 multiple times, disputing the service charges, and searched on competitor's website for the terms of similar services, this may signal the customer's desire to leave the current service. In addition, if a customer has not been paying the service charges in the last few months and the activity level on the service site is significantly lower, it may also signal the customer's propensity to churn. Given that, the collected information stored in the service database 140 may be analyzed to facilitate the learning and understanding of the relationships between presence of certain behavior/activity/observation with the rick of churn and reasons thereof.

FIG. 2B illustrates an exemplary information transformation process for churn prevention, from information collection, feature extraction, risk assessment, causal reasons prediction, to market actions to prevent churn, in accordance with an embodiment of the present teaching. As illustrated in FIG. 2B and FIG. 2A, information collected includes service data 140-1, event data 140-2, interaction data 140-3, customer data 140-4 (such as customer profiles), etc. From such collected information, various features may be extracted as shown in 200 of FIG. 2B. For instance, different signals may be identified such as intender signals that provide strong indication of propensity of churn (e.g., lock device to prepare transport of data to another service provider, test the service from a different provider, communication/search performed on how to discontinue services or on the steps to switch to a different service provider), high risk signals (e.g., cease to make regular payment, intermittent payment records, less frequent use of devices or services, payment before the end of contract term).

Such signals may be identified to generate different features 200, including, e.g., disengagement features 200-1 (features that indicate disengaging behavior), propensity features 200-2 (behavior suggesting likely churn behavior or indicative of risk of churn), causal features 200-3 (features that reveal underlying reasons of churn, e.g., poor experiences, consecutive bill increase, promotion expired, trial period ends, repeated malfunction of devices, etc.), intent features 200-4 (features that show user's desire, plan, or behavior to churn), and various customer features 200-5 (e.g., certain demographic groups may churn more frequently than others). These features extracted from the collected information in 140 transform the scattered data into targeted features representing the characteristics of each customer's behavior. In addition, these features may then be relied on to transform the customer features into different HTC segments 210 and causal segments 220, representing classifications of customers into different categories.

As discussed herein, the transformation from different types of features in 200 to HTC segments is via an HTC model, that may be developed to recognize, from different features, hyper target customers that are likely to churn. On the other hand, the transformation from different types of features in 200 into different causal segments is via a causal model, which may be developed to recognize the underlying causes for the individual churn behaviors. The HTC segments 210 and causal segments 220, together with customer information (e.g., profile with demographic information), are then used to transform the classified HTC segment and causal segment(s) of each customer into a decision or a recommendation of one or more market action(s) 230 to be carried out to prevent or minimize the churning of the customer.

FIG. 2C provides an example of determining a market action to be applied with respect to a customer based on a risk level to churn, a causal reason estimated associated with the risk, and a known customer profile, in accordance with an exemplary embodiment of the present teaching. In this example, a customer Cᵢ with a known customer profile is classified into HTC segment 2 with a high risk of churn and causal segment 5 associated with a causal reason of pricing. Given those classifications using the collected data associated with the customer, the market action to “offer a price discount” may be recommended to address the recognized high risk of churn with a targeted remedy specific to the recognized causal reason being related to the pricing.

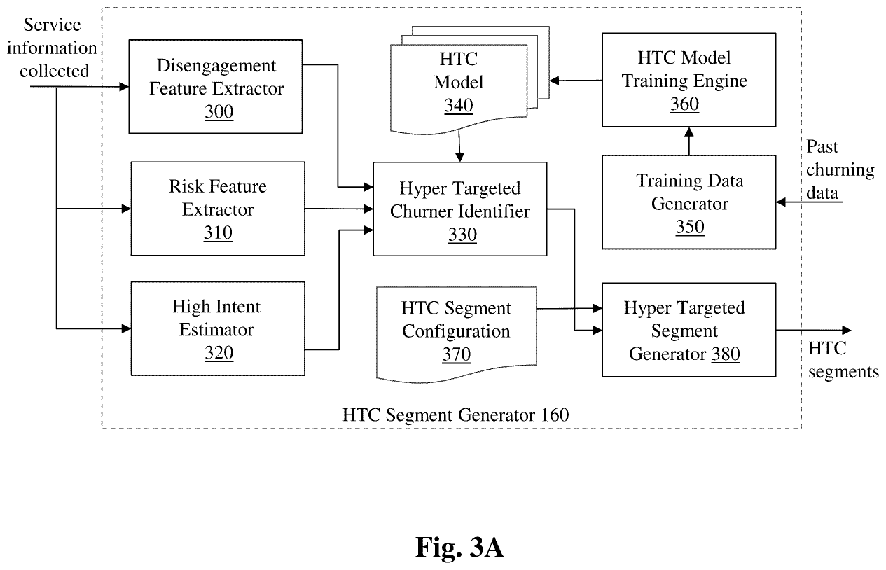

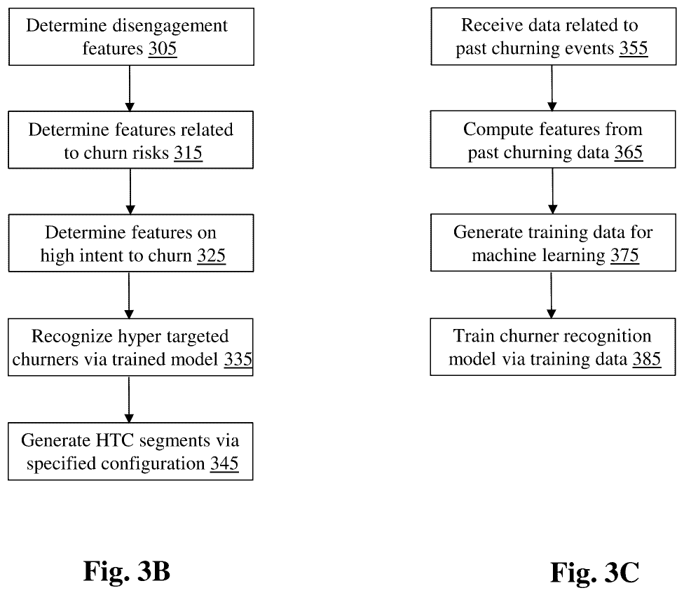

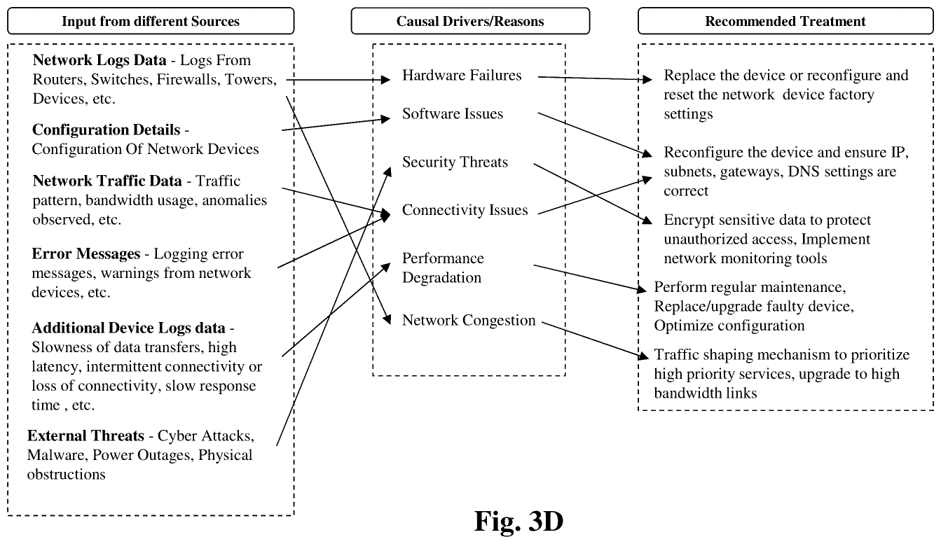

FIG. 3A depicts an exemplary high level system diagram of the HTC segment generator 160, in accordance with an embodiment of the present teaching. As discussed herein, the HTC segment generator 160 is provided for grouping customers 110 into different HTC segments in accordance with an HTC model obtained to recognize customers with different levels of risk of churn based on different features extracted from the collected information. In this illustrated embodiment, the features used for risk recognition include disengagement features, propensity (or risk) features, and intender features. As such, this exemplary HTC segment generator 160 takes the service information collected as input and produces HTC segments as output. As shown in FIG. 3A, the HTC segment generator 160 comprises a disengagement feature extractor 300, a rick feature extractor 310, a high intent estimator 320, a hyper targeted churner identifier 330, and a hyper targeted segment generator 380. The extractors 300, 310, and 320 are provided for determining disengagement, risk, and high intent related features from the collected service information. The hyper targeted churner identifier 330 is provided for recognizing churners with a certain risk level based on the various features from the extractors 300-320 based on an HTC model 340, which may be previously trained vis machine learning based on, e.g., past historic data related to churning activities.

That is, based on the features extracted with respect to each individual customer, the hyper targeted churner identifier 330 may estimate, based on the HTC model, a level of risk associated with each individual customer. The output of the hyper targeted churner identifier 330 may then be used by the hyper targeted segment generator 380 to create HTC segments according to the configuration in 370 that may specify, e.g., how the HTC segments are to be generated. For instance, some pre-determined criterion may be specified in 370 that define what constitutes “high risk of churn” so that any customers who is evaluated to have a risk level lower than the specified criterion may be considered as no risk of churn. In addition, the configuration in 370 may also specify how to group customers of varying levels of risks into segments. For instance, assuming that the risk of churn is normalized in a range of [0.0, 1.0], then a specification may specify to group customers into 4 segments, a first segment with all customers having a risk level of lower than 0.5, a second segment with customers having a risk level within [0.5-0.7], a third segment with customers having a risk level within [0.7-0.9], and a fourth segment with customers with a risk level within [0.9-1.0]. With such configuration, the hyper targeted segment generator 380 may then group the individually assessed customers with corresponding estimated risk levels into different HTC segments. It is noted that the exemplary configuration disclosed above is merely for an illustration rather than as limitation and any other specification according to the need of a particular application may be used within the scope of the present teaching.

FIG. 3B is a flowchart of an exemplary process for generating HTC segments via the HTC model 340 based on different features extracted from information collected, in accordance with an embodiment of the present teaching. As discussed herein, when the input is received with information collected during the services, the disengagement feature extractor 300 determines, at 305, the disengagement features associated with each individual customer; the risk feature extractor 310 determines, at 315, the risk features associated with each individual customer; the high intent feature extractor 320 determines, at 325, the features associated with a high intent to churn with respect to each individual customer. With such computed features characterizing different aspects of potential churning behavior, the hyper targeted churner identifier 330 recognizes, at 335, churners among customers and the corresponding risks of churn with respect to the individual customers in accordance with the previously trained HTC model 340. Based on the individual assessment of churning risk levels of customers, the hyper targeted segment generator 380 then generates, at 345, output HTC segments according to the criterion specified in the HTC segment specification in 370.

As discussed herein, the HTC model 340 is for estimating or predicting the level of risk of each customer based on associated features extracted from information collected with respect to the customer. The HTC segment generator 160 may further include a training data generator 350 and an HTC model training engine 360 for generating and dynamically adapting, when needed, the HTC model 340. FIG. 3C is a flowchart of an exemplary process for obtaining the HTC model 340 via machine learning based on training data created from past churning data, in accordance with an embodiment of the present teaching. The training data generator 350 may receive, at 355, past churning records/data as input and computes, at 365, various relevant features from the input in order to generate, at 375, training data for machine learning. For example, the past churning records may record the historic churning event and information related to activities/observations prior to the historic churning events associated with the customers involved. Such training data may reveal the relationship or correlation between the churning behavior and various observed events/activities occurred prior to the churnings and may be used for training the HTC model 340 to gain knowledge therefrom and capture the relationship or correlation between prior behaviors and the churning events. Such generated training data may then be provided to the HTC model training engine 360 for carrying out the machine learning, at 385, to establish or update the HTC model 340.

As discussed herein, the present teaching may be applied to a variety of applications, including service delivery, network transmission or the like. For example, with respect to FIG. 3C, the step 355 on receiving data related to past churning event may correspond to, in other use cases, receiving data related to past events that are defined as undesirable such as network, key performance indicator (KPI) and/or software anomalies. The step 365 on computing features from past churning data may correspond to, in other use cases, computing features from the data related to the past undesirable events. The step 375 of generate training data for machine learning can be similarly carried out based on the received data related to the past undesirable events and the computed features thereof. The step 385 on training a churner recognition model via the training data may correspondingly be training a recognition model based on the training data to recognize the undesirable event.

FIG. 3D provides an example use case associated with network services when the present teaching is applied thereto to recognize risk of network, software, or service malfunction, identify causal reasons associated with the network malfunction, and treatment that may be deployed targeting at each identified causal reason to prevent or minimize the occurrence of network malfunction. As shown, input data from different sources may be gathered and used to identify risk levels. This includes data related to network logs from different sources, e.g., logs from routers, network switches, firewalls, towers, devices, etc.; data related to configuration details or configuration parameters of network devices; data related to traffic pattern, bandwidth usage, anomalies observed, etc.; data related to errors such as logging error messages, warnings from network devices, etc.; other device logs data such as slowness of data transfers, high latency, intermittent connectivity or loss of connectivity, slow response time, etc.; and/or data on external threats such as information recorded on cyber-attacks, malware, power outages, physical obstructions, etc.

In this illustrated example, there may be different causal reasons/drivers that may lead to network malfunction, including, e.g., hardware failures, software issues, security threats, connectivity issues, performance degradation, network congestion, etc. According to the present teaching, data collected from past network malfunction may be collected and used to learn to recognize causal reasons/drivers in different situations leading up to the malfunction. In some embodiments, model(s) may be obtained via machine learning from training data created based on the past data associated with network malfunction events and features computed therefrom. Such model(s) may then be used for identifying causal reasons related to each situation. Each of the recognized causal reasons may be linked to one or more appropriate treatment that may be deployed to remove the causal reason to minimize the network malfunction. For instance, in this illustrated example as shown in FIG. 3D, with respect to causal reason “hardware failures,” the treatment may be “replace the device or reconfigure and reset the network device factory settings.” With respect to causal reason “software issues” and “connectivity issues,” the treatment may be “reconfigure the device and ensure IP, subnets, gateways, DNS settings are correct.” With respect to causal reason “security threats,” the treatment may be “encrypt sensitive data to protect unauthorized access, implement network monitoring tools.” With respect to causal reason “performance degradation,” the treatment may be “perform regular maintenance, replace/upgrade faulty device, optimize configuration.” With respect to causal reason “network congestion,” the treatment may be “traffic shaping mechanism to prioritize high priority services, upgrade to high bandwidth links.”

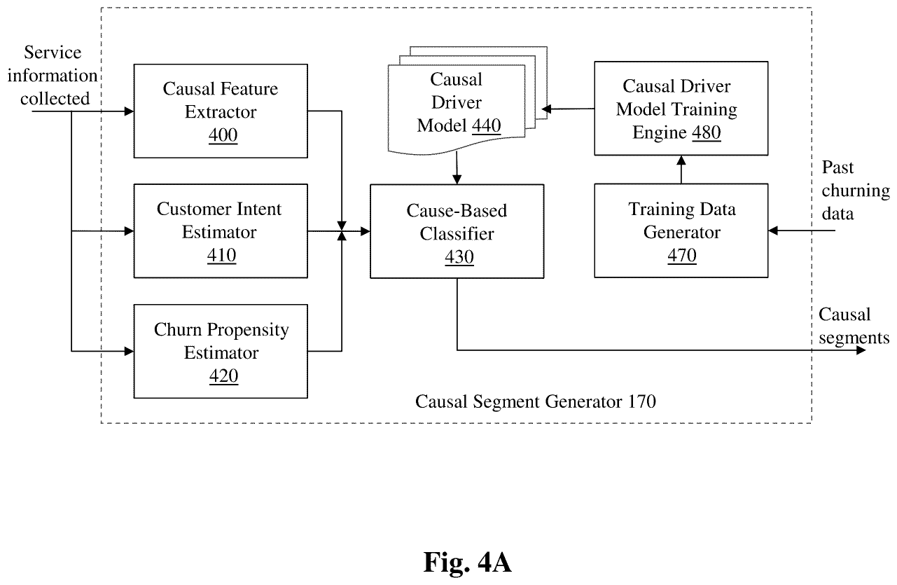

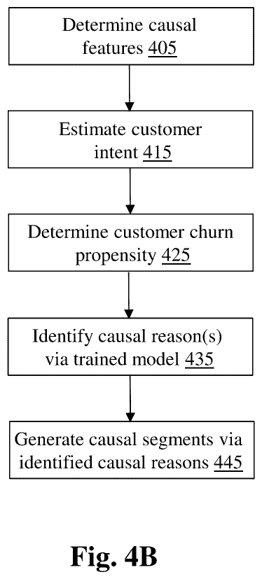

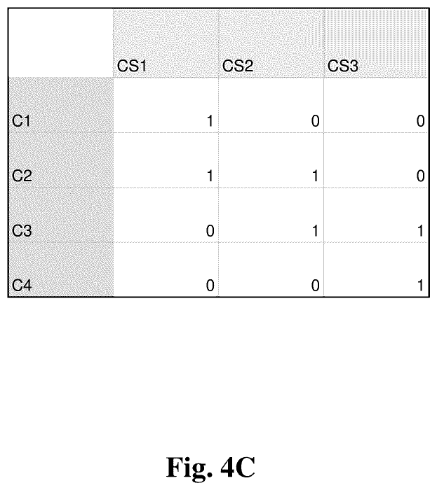

FIG. 4A depicts an exemplary high level system diagram of the causal segment generator 170, in accordance with an embodiment of the present teaching. As discussed herein, the causal segments are also generated based on relevant features extracted from the collected information related to the customers, services, activities, and communications between the customers and the service provider 120. In some embodiments, features used to determine causal segments may include causal features 200-3, intent features 200-4, and churn propensity features 200-2. Based on these features extracted with respect to each customer, assessment may be performed, in accordance with a causal driver model, to determine what causal reasons may be present so that the customer may be driven to churn. For each causal reason so identified, the customer is classified into a causal segment associated with the causal reason. As discussed herein, in some situations, multiple reasons may be present for a customer and in this case, the customer may fall into different causal segments.

To generate causal segments based on information collected, the illustrated causal segment generator 170 as shown in FIG. 4A comprises a causal feature extractor 400, a customer intent estimator 410, a churn propensity estimator 420, and a cause-based classifier 430. The causal feature extractor 400 is provided to determine, with respect to each customer, likely reasons that may drive a customer to churn based on information relevant to the customer. For example, the customer may have called to indicate price hikes, reports on poor network connection, expiration of a promotion provided to the customer, repeated malfunction of a device, etc. The customer intent estimator 410 is provided for estimating the intent of a customer to churn based on information from different sources, e.g., calls/chats/remarks of the customer complaining about bad experiences, searches on how to switch to a different service provider, or requests made to return devices, paying off outstanding invoices, etc. The churn propensity estimator 420 may be provided to evaluate the level of risk of each customer to churn based on different types of information such as repeated complaint on bad user experience and network connection problems, and questions on how to return a device associated with the services, etc.

As discussed herein, each causal segment may have an associated cause or causal reason known to likely drive a customer to churn. Whether a customer belongs to a causal segment (i.e., is associated with a causal reason that may drive the customer to churn) depends on whether the various features detected with respect to the customer may indicate that some causal reason(s) are present with respect to the customer. This may be determined by the cause-based classifier 430, in accordance with a causal driver model 440, based on various features detected from data associated with the customer, e.g., the causal features (from causal feature extractor 400), the intent of the customer (from the customer intent determiner 410), and the risk or propensity of the customer to churn (from the churn propensity determiner 420). If a causal reason is identified with respect to a customer based on the causal driver model 440, the cause-based classifier 430 may label the customer to be in a causal segment associated with the causal reason.

The causal driver model 440 plays a crucial role to predicting, based on various features associated with a customer, the causal reason(s) associated therewith and generating a causal segment label for the customer. According to the present teaching, the causal driver model 440 is obtained via machine learning based on training data from historic churning information. Thus, the illustrated embodiment of the causal segment generator 170 also includes a training data generator 470 and a causal driver model training engine 480. The training data generator 470 is provided for processing the past churning data to generate training data with, e.g., various features and the identified causal reasons related to the churnings of different departed customers. Such training data may then be used by the causal driver model training engine 480 to train the causal driver model 440 to learn the relationships between various features and different causal reasons.

FIG. 4B is a flowchart of an exemplary process for the causal segment generator 170, in accordance with an embodiment of the present teaching. As discussed herein, when the information collected from services to customers is received, it is analyzed to detect different types of features to be used to identify causal reasons/segments. For example, the causal feature extractor 400 extracts or determine, at 405, features from the input data that may be indicative of reasons that may be linked to churn behavior. The customer intent estimator 410 estimates, at 415, based on the input data the intent of each customer associated with churn. The churn propensity estimator 420 estimates, at 425, the risk or propensity of each customer to churn based on different types of information included in the input data. In some embodiments, the churn propensity estimated may correspond to a score indicating the level of likelihood that a customer may churn. With estimated features with respect to each customer, the cause-based classifier 430 identifies, at 435, possible causal reason(s) in accordance with the trained causal driver model 440 and then generates, at 445, causal segments according to the causal reason(s) recognized for each of the customers.

FIG. 4C shows an example table representing causal segments with customers therein obtained according to the present teaching. In this example, there are four customers C1, C2, C3, and C4 and three causal segments CS1, CS2, and CS3. Each of the causal segment is associated with a specific cause of churn. For instance, CS1 may correspond to causal reason “price;” CS2 may correspond to causal reason “intermittent connections;” and CS3 may correspond to causal reason “promotion end.” The result shows that customer C1 is in causal segment 1, i.e., the causal reason on “price” is detected (e.g., information associated with this customer may indicate that the customer called to complain about the price). Customer C2 is shown to be in CS1 and CS2, i.e., both causal reason 1 on price and causal reason 2 on intermittent network connection are detected. Customer C3 is also in two causal segments, i.e., CS2 and CS3, which indicates that both causal reasons on “intermittent connection” and “promotion end” are detected with respect to customer 3. Customer 4 is in CS3 based on a detected causal reason related to “promotion end.”

As discussed herein, the present teaching aims to prevent churn by employing market actions determined based on the estimated churn risk and causal reasons estimated for each customer based on information related to thereto. Via the processing disclosed herein, customers are classified into different HTC segments 210 at different level of churn risks and causal segments 220 identifying specific causal reasons of customers. As depicted in FIG. 1A and FIG. 2B, HTC segments 210 and causal segment 220 are then used, together with customer data (e.g., characterized via customer profiles), by the market action recommender 180 to recommend targeted market actions appropriate for individual customers to prevent customers at a high risk from churning.

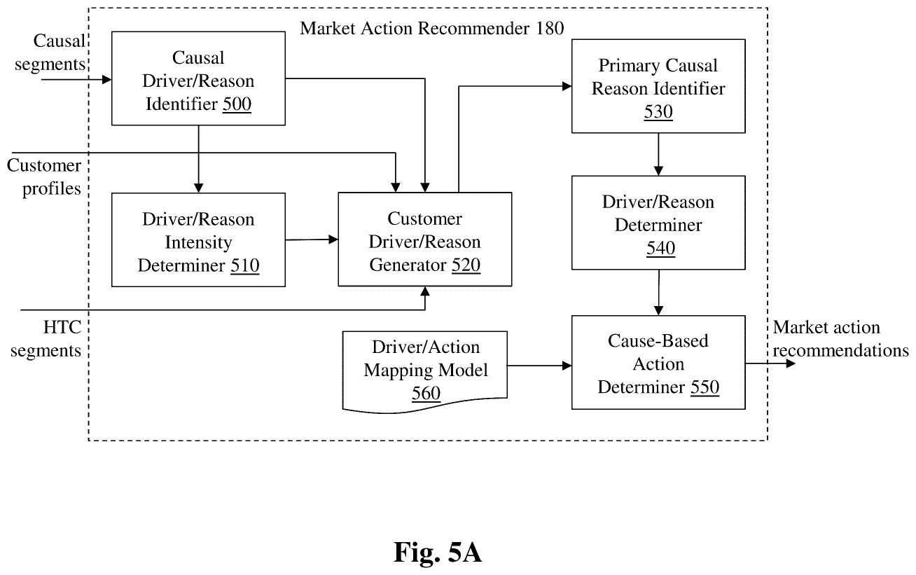

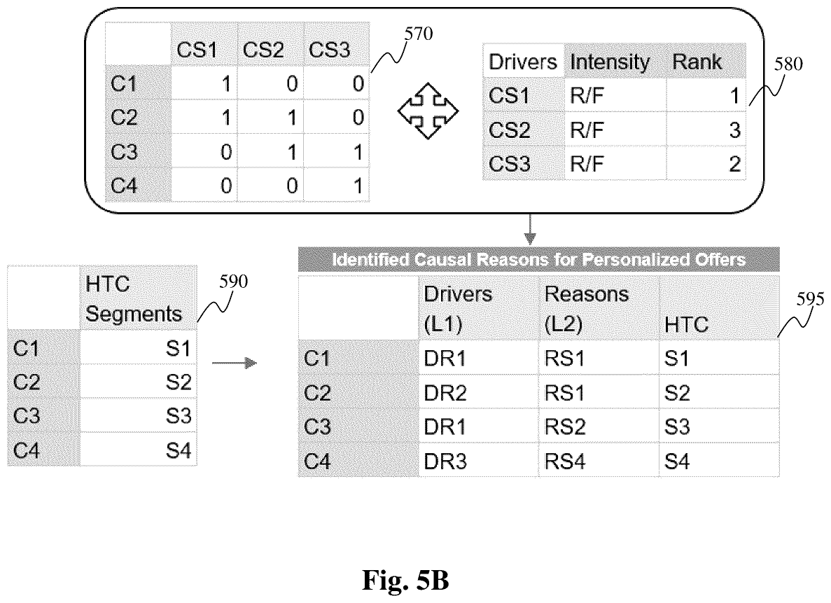

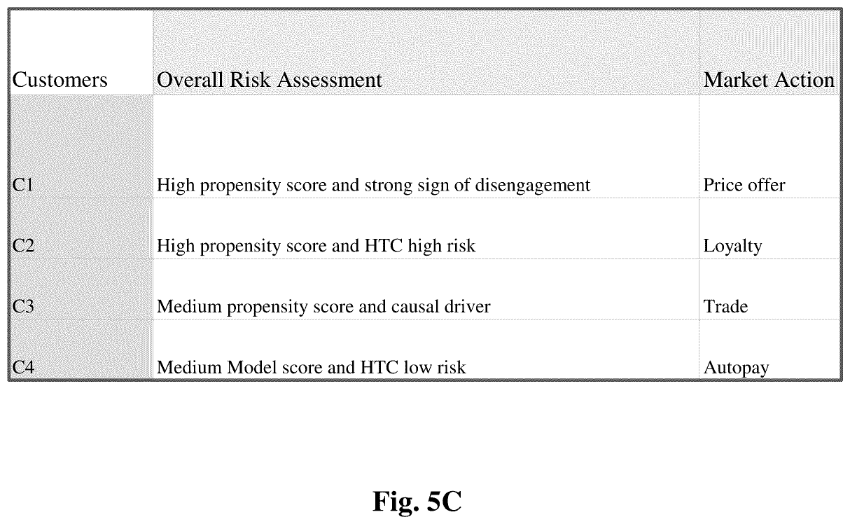

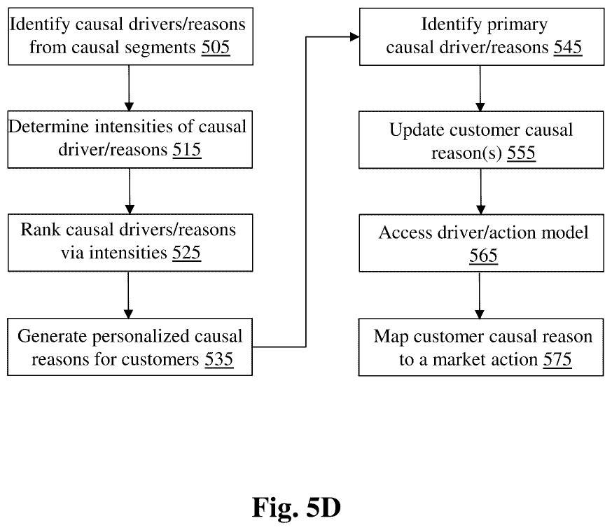

FIG. 5A depicts an exemplary high level system diagram of the market action recommender 180, in accordance with an embodiment of the present teaching. In this illustrated embodiment, the market action recommender 180 comprises a causal driver/reason identifier 500, a driver/reason intensity determiner 510, a customer driver/reason generator 520, a primary causal reason identifier 530, a driver/reason determiner 540, and a cause-based action determiner 550. The market action recommender 180 takes HTC segments 210, causal segment 220, and customer information such as profile as input and output recommended market actions for the customers. In some embodiments, market actions may be recommended with respect to some customers at a level of risk of churn above some pre-determined threshold and no market action is recommended for customers who are at no or low risk of churn. In some embodiments, for customers with more than one causal reason identified, more significant or relevant causal reasons may be addressed via recommended market actions, while leaving less prominent causal reasons at a, e.g., a monitoring status. In some situations, causal reasons identified with respect to customers may be ranked so that more significant or prevalent causal reasons may be recognized and addressed, e.g., with more urgency or more effective means to prevent churn. Variations in strategy to prevent churn with cause-based market actions may be considered and employed in each application based on the specific situation and needs associated with the application.

In the illustrated embodiment shown in FIG. 5A, the causal driver/reason identifier 500 may be provided for identify causal reasons estimated for the customers. This may be needed because some of the known causes for churn may not necessarily present each time so that the causal driver/reason identifier 500 may identify those that are currently present. The driver/reason intensity determiner 510 may be provided to assess the intensity or severity of the current present causal reasons. Different criteria may be employed for evaluating the intensity of the detected causal reasons. For instance, recency of the detected causal reason may be used to see how relevant the causal reason is at the time to recommend a market action. As another example, frequency at which a causal reason is detected may also be considered. The higher the frequency, the more intense is the causal reason. Recency and frequency may also be jointly considered when evaluate the intensity of a causal reason.

Such assessed intensities for causal reasons currently detected may be utilized to rank the causal reasons. For example, a causal reason ranked high may indicate that it is associated with a higher intensity (i.e., more recent and/or more frequently occurring) so that it needs to be addressed more urgently. This is illustrated in FIG. 5B, where a table labeled as 570 represents currently detected causal segments detected from information collected, and table 580 represents rankings of these causal segments. For example, rows of table 570 correspond to customers (e.g., C1, C2, C3, and C4) and columns of table 570 represent different causal segments (reasons) such as CS1, CS2, and CS3. The intensities of each currently detected causal reason/segment may be assessed based on, e.g., recency/frequency (RF) thereof to obtain a ranking. As shown in FIG. 5B, in this example, the causal segment (reason) CS2 is ranked highest at 3, CS3 is ranked at 2, and CS1 is ranked at the lowest level 1.

With the currently present causal reasons identified (by the causal driver/reason identifier 500) and ranked (by the driver/reason intensity determiner 510), the customer driver/reason generator 520 is provided to combine such results with HTC segments that include different groups of customers at different levels of risks of churn. This is illustrated in FIG. 5B, where results shown in tables 570 and 580 may be combined with HTC segments in 590 to yield a table 595. As shown, rows of table 590 correspond to customers, each of which has an HTC label indicating which HTC segments the customers are in. For instance, customer C1 is in HTC segment S1, C2 in S2, etc. In the combined table 595, each row corresponds to a customer and different columns represents, respectively, the identified drivers, reasons, and the level of risk of churn associated with an HTC segment that the customer is in. As can be seen, based on table 595, each customer included therein is characterized by a level of churn risk and one or more causal driver/reasons identified.

In some embodiments, with respect to identified causal driver/reasons, primary or more important causal reason(s) may be further identified. In different embodiments, what constitute primary or more important causal reasons may be specified based on application needs and may vary from applications to applications. For instance, in some applications, a causal reason that more directly leads to churn (consequential) may be defined as primary, while in other applications, a causal reason may be defined as one that impact the highest number of customers. The primary causal reason identifier 530 in FIG. 5A may be provided to determine primary causal reason(s) from the currently present ones. It is noted that the primary may include one or more causal reasons. Based on the determination of primary causal driver/reason(s), the driver/reason determiner 540 may be provided to generate an updated result on the final drivers/reasons for individual customers so that the cause-based action determiner 550 can recommend market actions to be carried out to prevent churn based on such determined causal drivers/reasons. The recommended market actions may be obtained by mapping each causal driver/reason to a market action according to a driver/action mapping model 560. In some embodiments, the driver/action mapping model 560 may be implemented as a look-up table (LUT). In some embodiments, the driver/action mapping model 560 may be derived via machine learning based on past service management data on churn prevention. FIG. 5C illustrates an exemplary mapping result for a number of customers based on estimated churn risk and associated causal driver/reason, in accordance with an embodiment of the present teaching.

FIG. 5D is a flowchart of an exemplary process of the market action recommender 180, in accordance with an embodiment of the present teaching. Upon receiving the causal segments 220, the currently present causal drivers/reasons may be identified at 505. The intensities of these currently present causal drivers/reasons may be determined at 515 based on, e.g., some predetermine criterion. The currently present causal driver/reasons may be ranked, at 525, according to, e.g., the corresponding intensities as assessed. The currently present causal drivers/reasons with corresponding intensities/ranks may then be used, in combination with HTC segments 210, to obtain, at 535, personalized causal driver/reason(s) associated with each customer. For instance, for each customer included in each of the HTC segments, relevant causal segment(s) that include the customer therein may be identified. The causal reasons associated with the relevant causal segments may then be recognized as the causal reason(s) of the customer.

In some embodiments, before market actions for identified causal reasons are determined, primary causal driver/reason(s) may be identified at 545. For instance, causal reasons may be assessed based on their ranks and it may be defined that the top ranked causal reasons (e.g., top two ranked) may be considered as primary causal reasons. In some situations, for each customer, it may be set that only primary causal reason(s) may be retained so that the causal driver/reason for each customer may be updated accordingly at 555. The updated information for each customer with the underlying cause(s) to churn may then be used to determine corresponding market action(s) to prevent churn. To do so, the driver/action mapping model 560 is accessed at 565 and used to map, at 575, each causal reason to a market action to be carried out to prevent the customer from churning.

As discussed herein with reference to FIG. 1A, with the market action(s) recommended with respect to different customers based on causal reasons automatically detected from information related to the customers, the action execution mechanism 190 may carry out, optionally together with the service provider 120, the recommended market actions in an effort to prevent the customers from churning. As can be seen from the discussion herein, the churn prevention engine 150 according to the present teaching aims to prevent churn via market actions that directly address the underlying reasons associated with individual customers so that it is more effective and more likely resolve the root cause of the potential churn events. In addition, as the underlying causal reasons associated with the risk of churn with respect to each customer are identified based on dynamic data collected during the services, such causal reasons are recognized in an adaptive manner and reflective of the changing situations. Compared with the traditional probabilistic approaches for preventing churn, the present teaching provides an improved solution that is causality-aware via automated determination of causal reasons associated with individual customers, targeted churn prevention by taking market actions automatically recommended with respect to specific causes, personalized with individualized treatment, and adaptive as the causal reasons are dynamically estimated based on information collected in delivering services.

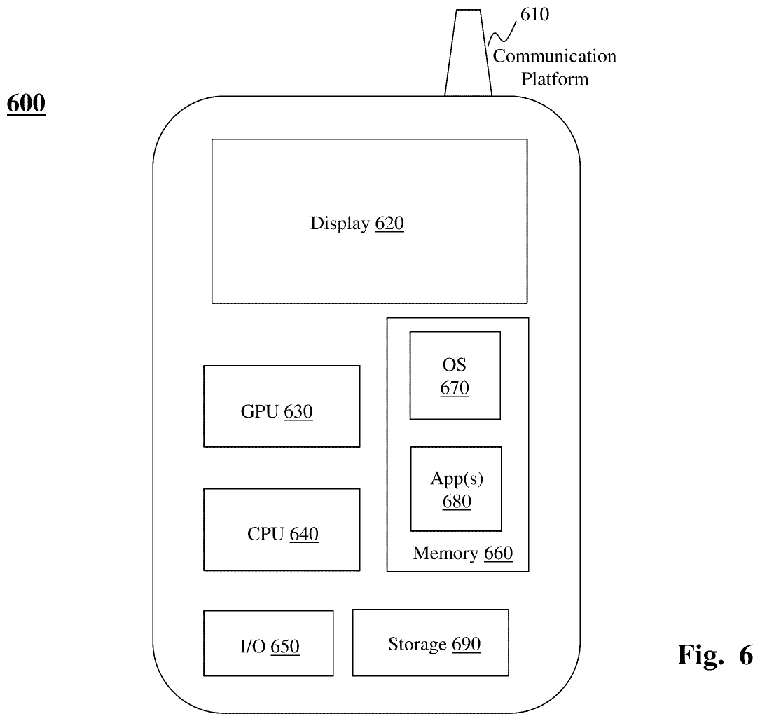

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or a mobile computational unit in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.) and one or more applications 680 may be loaded into memory 660 from storage 690 in order to be executed by the CPU 640. The applications 680 may include a user interface or any other suitable mobile apps for information exchange, analytics, and management according to the present teaching on, at least partially, the mobile device 600. User interactions, if any, may be achieved via the I/O devices 650 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

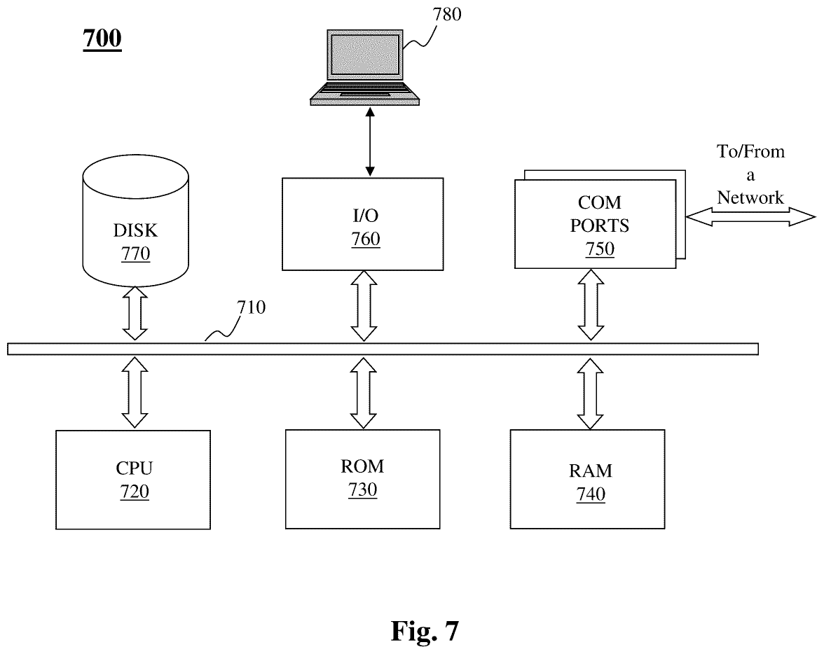

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information processing and analytical method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
collecting information associated with services provided to a plurality of customers;
generating hyper targeted churn (HTC) segments based on the collected information, wherein each of the multiple HTC segments corresponds to a level of risk to churn and includes one or more of the plurality of customers estimated to be at a corresponding level of rick to churn;
generating causal segments based on the collected information, wherein each of the one or more causal segments corresponds to a causal reason to drive a customer to churn and includes at least one of the plurality of customers estimated to have an underlying causal reason corresponding to that of the causal segment;
with respect to each of some of the plurality of customers,
estimating, based on the information, the HTC segments, and the causal segments, at least one causal reason, each of which corresponds to an underlying cause that potentially drives the customer to churn,
recommending a market action directed to each of the at least one causal reason,
executing the market action to address the corresponding underlying cause to churn to prevent the customer to churn.

2. The method of claim 1, wherein the generating the HTC segments comprises:
with respect to each of the plurality of customers and based on the information relevant to the user,
extracting disengagement features of the customer,
determining an intent of the customer to churn based on the features and the relevant information,
estimating a level of risk to churn associated with the customer, and
identifying whether the customer corresponds to a churner in accordance with an HTC model; and
creating the HTC segments at different levels of risk to churn, wherein each of the HTC segments associated with a level of risk to churn includes those of the plurality of customers identified as a churner and having an estimated level of risk to churn corresponding to the associated level of risk to churn.

3. The method of claim 2, wherein the HTC model is previously trained via machine learning to capture characteristics of a churner based on historic churning data.

4. The method of claim 1, wherein the generating the causal segments comprises:
with respect to each of the plurality of customers and based on the information relevant to the user,
extracting causal features of the customer,
determining an intent of the customer to churn based on the causal features and the relevant information,
estimating propensity of the customer to churn, and
predicting a causal reason associated with the customer in accordance with a causal driver model; and
creating the causal segments with corresponding causal reasons, wherein each of the causal segments associated with a causal reason includes those of the plurality of customers predicted to have a causal reason corresponding to the associated causal reason.

5. The method of claim 4, wherein the causal driver model is previously trained via machine learning to capture characteristics of a customer with a causal reason based on historic churning data.

6. The method of claim 1, wherein the estimating the at least one causal reason comprises:
determining an intensity of each of the causal reasons associated with the causal segments;
ranking the causal reasons according to the respective intensities associated therewith;
obtaining one of the HTC segments that includes the customer;
identifying one or more of the multiple causal segments that include the customer; and
obtaining the at least one causal reason associated with the one or more causal segments associated with the customer.

7. The method of claim 1, wherein the recommending a market action directed to each of the at least one causal reason comprises:
with respect to each of the at least one causal reason,
accessing a driver/action mapping model, and
mapping, via the driver/action mapping model, the causal action to a corresponding market action.

8. A machine-readable medium having information recorded thereon, wherein the information, when read by the machine, causes the machine to perform the following steps:
collecting information associated with services provided to a plurality of customers;
generating hyper targeted churn (HTC) segments based on the collected information, wherein each of the multiple HTC segments corresponds to a level of risk to churn and includes one or more of the plurality of customers estimated to be at a corresponding level of rick to churn;
generating causal segments based on the collected information, wherein each of the one or more causal segments corresponds to a causal reason to drive a customer to churn and includes at least one of the plurality of customers estimated to have an underlying causal reason corresponding to that of the causal segment;
with respect to each of some of the plurality of customers,
estimating, based on the information, the HTC segments, and the causal segments, at least one causal reason, each of which corresponds to an underlying cause that potentially drives the customer to churn,
recommending a market action directed to each of the at least one causal reason,
executing the market action to address the corresponding underlying cause to churn to prevent the customer to churn.

9. The medium of claim 8, wherein the generating the HTC segments comprises:
with respect to each of the plurality of customers and based on the information relevant to the user,
extracting disengagement features of the customer,
determining an intent of the customer to churn based on the features and the relevant information,
estimating a level of risk to churn associated with the customer, and
identifying whether the customer corresponds to a churner in accordance with an HTC model; and
creating the HTC segments at different levels of risk to churn, wherein each of the HTC segments associated with a level of risk to churn includes those of the plurality of customers identified as a churner and having an estimated level of risk to churn corresponding to the associated level of risk to churn.

10. The medium of claim 9, wherein the HTC model is previously trained via machine learning to capture characteristics of a churner based on historic churning data.

11. The medium of claim 8, wherein the generating the causal segments comprises:
with respect to each of the plurality of customers and based on the information relevant to the user,
extracting causal features of the customer,
determining an intent of the customer to churn based on the causal features and the relevant information,
estimating propensity of the customer to churn, and
predicting a causal reason associated with the customer in accordance with a causal driver model; and
creating the causal segments with corresponding causal reasons, wherein each of the causal segments associated with a causal reason includes those of the plurality of customers predicted to have a causal reason corresponding to the associated causal reason.

12. The medium of claim 11, wherein the causal driver model is previously trained via machine learning to capture characteristics of a customer with a causal reason based on historic churning data.

13. The medium of claim 8, wherein the estimating the at least one causal reason comprises:
determining an intensity of each of the causal reasons associated with the causal segments;
ranking the causal reasons according to the respective intensities associated therewith;
obtaining one of the HTC segments that includes the customer;
identifying one or more of the multiple causal segments that include the customer; and
obtaining the at least one causal reason associated with the one or more causal segments associated with the customer.

14. The medium of claim 8, wherein the recommending a market action directed to each of the at least one causal reason comprises:
with respect to each of the at least one causal reason,
accessing a driver/action mapping model, and
mapping, via the driver/action mapping model, the causal action to a corresponding market action.

15. A system, comprising:
a service information collector implemented by a processor and configured for collecting information associated with services provided to a plurality of customers;
a hyper targeted churn (HTC) segment generator implemented by a processor and configured for generating HTC segments based on the collected information, wherein each of the multiple HTC segments corresponds to a level of risk to churn and includes one or more of the plurality of customers estimated to be at a corresponding level of rick to churn;
a causal segment generator implemented by a processor and configured for generating causal segments based on the collected information, wherein each of the one or more causal segments corresponds to a causal reason to drive a customer to churn and includes at least one of the plurality of customers estimated to have an underlying causal reason corresponding to that of the causal segment;
a market action recommender implemented by a processor and configured for, with respect to each of some of the plurality of customers,
estimating, based on the information, the HTC segments, and the causal segments, at least one causal reason, each of which corresponds to an underlying cause that potentially drives the customer to churn, and
recommending a market action directed to each of the at least one causal reason; and
an action execution mechanism implemented by a processor and configured for executing the market action to address the corresponding underlying cause to churn to prevent the customer to churn.

16. The system of claim 15, wherein the generating the HTC segments comprises:
with respect to each of the plurality of customers and based on the information relevant to the user,
extracting disengagement features of the customer,
determining an intent of the customer to churn based on the features and the relevant information,
estimating a level of risk to churn associated with the customer, and
identifying whether the customer corresponds to a churner in accordance with an HTC model; and
creating the HTC segments at different levels of risk to churn, wherein each of the HTC segments associated with a level of risk to churn includes those of the plurality of customers identified as a churner and having an estimated level of risk to churn corresponding to the associated level of risk to churn, wherein
the HTC model is previously trained via machine learning to capture characteristics of a churner based on historic churning data.

17. The system of claim 15, wherein the generating the causal segments comprises:
with respect to each of the plurality of customers and based on the information relevant to the user,
extracting causal features of the customer,
determining an intent of the customer to churn based on the causal features and the relevant information,
estimating propensity of the customer to churn, and
predicting a causal reason associated with the customer in accordance with a causal driver model; and
creating the causal segments with corresponding causal reasons, wherein each of the causal segments associated with a causal reason includes those of the plurality of customers predicted to have a causal reason corresponding to the associated causal reason.

18. The system of claim 17, wherein the causal driver model is previously trained via machine learning to capture characteristics of a customer with a causal reason based on historic churning data.

19. The system of claim 15, wherein the estimating the at least one causal reason comprises:
determining an intensity of each of the causal reasons associated with the causal segments;
ranking the causal reasons according to the respective intensities associated therewith;
obtaining one of the HTC segments that includes the customer;
identifying one or more of the multiple causal segments that include the customer; and
obtaining the at least one causal reason associated with the one or more causal segments associated with the customer.

20. The system of claim 15, wherein the recommending a market action directed to each of the at least one causal reason comprises:
with respect to each of the at least one causal reason,
accessing a driver/action mapping model, and
mapping, via the driver/action mapping model, the causal action to a corresponding market action.
